(19) United States
(12) Patent Application Publication
(10) Pub. No.: US 2012/0172014 A1
(43) Pub. Date: Jul. 5, 2012

(54) Detect and Disable Text messaging function of handheld mobile cellular communication device in a moving vehicle.

(76) Inventor: HOWARD HERBERT SMITH, Temecula, CA (US)

(21) Appl. No.: 13/158,404

(22) Filed: Jun. 11, 2011

Related U.S. Application Data
(60) Provisional application No. 61/428,899, filed on Dec. 31, 2010.

(51) Int. Cl. H04W 4/02

(52) U.S. Cl. 455/414.1

(57) ABSTRACT

A method of using a plurality of apparatus, systems, computer application software and communication protocols to create a state that detects and disables the functions of text messaging or voice communication of handheld mobile cellular devices while operating moving vehicle in the form of one and collectively automobile, aircraft, watercraft and locomotive.

In broad embodiment, the present invention detects and disables text messaging function of handheld communication device used by an operator of a moving vehicle.

The present invention is subject to many variations, modifications and changes in detail. It is intended that all matter described throughout the specification and shown in the accompanying drawings be considered illustrative only. Accordingly, it is intended that the invention be limited only by the spirit and scope of the invention as claimed.

This application claims the benefit of U.S. Provisional Application No. 61/428,899 filed Dec. 31, 2010

### CROSS-REFERENCE TO RELATED APPLICATIONS

Current U.S. Class: 379, 379/8, 379/93.02, 379/185, 379/433.07, 379/433.09, 379/912-913, 379/915-916, 701/201, 455/429

Field of search: 244, 326, 340, 342, 343, 367, 379, 380, 455, 701, 717

U.S. Patent References

| | | |
|---|---|---|
| 6,842,773 | January, 2005 | Ralston, et al |
| 6,885,738 | April, 2005 | White, et al |
| 7,822,540 | October, 2010 | Fukaya, et al |
| 7,260,391 | August, 2007 | Hutchinson |

### BACKGROUND OF THE INVENTION

The present invention relates to a method of detecting and disabling the text messaging function of mobile cellular device while operating any moving vehicle.

Currently, the use of text messaging function in handheld communication devices by operators of moving vehicles has caused and continues to cause unnecessary deaths of both human and other living things and destruction of property.

Therefore, the primary object of the present invention is to detect and disable the function of text messaging and telephonic use of mobile cellular devices while operating a moving vehicle and thereby solves problems and deficiencies in the art.

### BRIEF SUMMARY OF INVENTION

The present invention is in the technical field of telephonic communication technologies.

More particularly the present invention is in the technical field of handheld mobile cellular communication technologies.

More particularly the present invention is the technical field of text messaging and voice use of mobile cellular communication device.

A method of using apparatus, computer software, Global Positioning System (GPS) and Communication protocols to detect and disable the text messaging and telephonic functions of handheld mobile cellular devices while the user is operating a moving vehicle such as automobile, aircraft, watercraft, locomotives.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples.

### BRIEF DESCRIPTION OF DRAWINGS

For a more complete understanding of the present invention and its advantages, reference is now made to the following description taken in conjunction with the accompanying drawings, in which:

FIG. 1 is a flowchart of sequence of events that trigger the present invention action.

FIG. 2 shows the embodiment of handheld mobile cellular communication device.

FIG. 3 is view of keyboard or touchscreen keyboard showing pressed key.

FIG. 4 Diagram shows the sequence of the present invention.

### DETAIL DESCRIPTION AND EXEMPLARY EMBODIMENT

The present invention is embodied in the handheld mobile cellular device programmed to detect the use text messaging function through a combination of mathematical calculation which includes variable parameters utilizing GPS or radio frequency or cellular communication tracking method.

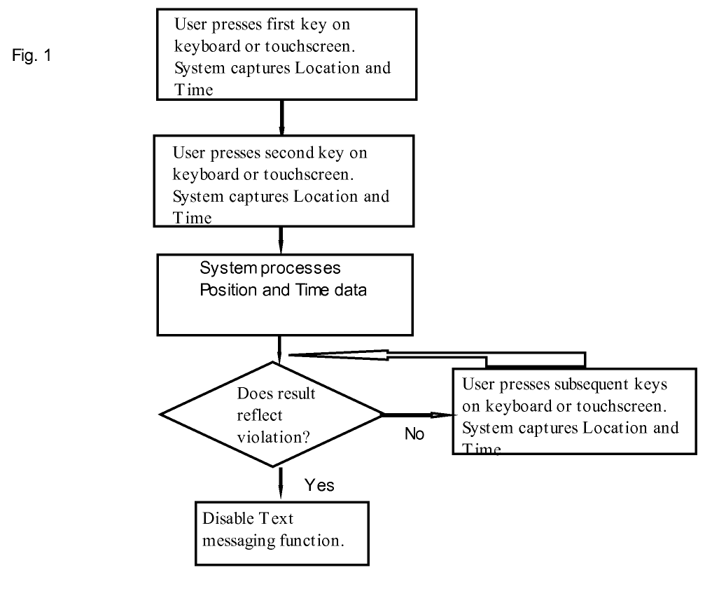

FIG. 1 The present invention seeks to use methods and systems to detect and disable text messaging function of handheld mobile cellular communication device through series of sequential events.

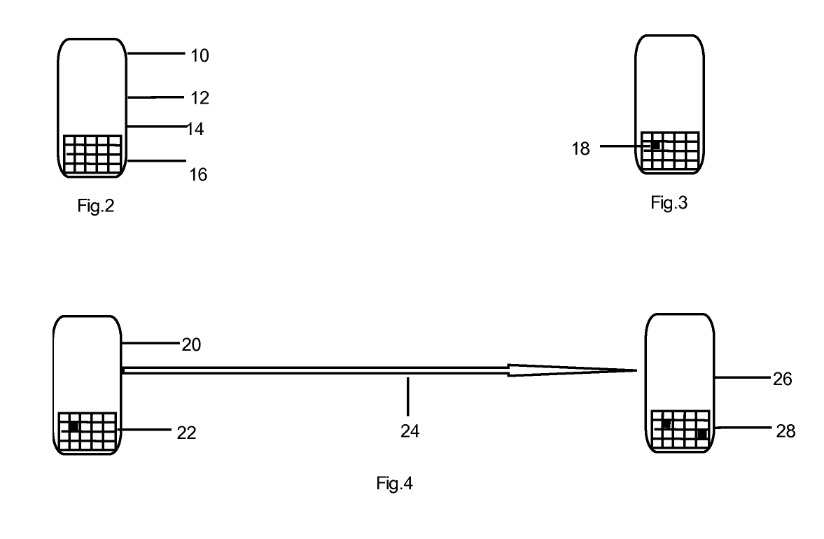

FIG. 2 shows the embodiment of handheld mobile cellular communication device 10 encompassing user interface screen 12 and 14 embedded integrated microprocessor chip unit processor for the handheld mobile cellular communication device.

Item 16 depicts representation of keyboard or touchscreen keyboard as integral part of the handheld mobile cellular communication device 10.

FIG. 3 shows composite of FIG. 2 in addition to key pressed indicator of 18. FIG. 2 and FIG. 3 establish the basic environment for utilizing text messaging function of handheld mobile cellular communication device 10.

FIG. 4 Item 20 simulates the starting location of the handheld mobile cellular communication device with 22 as depicting the first key press of keyboard 16 at which time the present invention proposes the capture of GPS Radio wave location coordinate G(1)) and time of input as T(1) into embedded integrated microprocessor chip unit processor 14. In the context of travel properties of a moving vehicle 24 leads onto next location of handheld mobile cellular communication device 26 and second key pressed 28 of keyboard 16 at which time the present invention proposes the capture of GPS Radio wave location coordinate G(2) and time of input as T(2) into embedded integrated microprocessor chip unit processor 14.

The present invention's chip embedded logic software processes for a result set R=(G(2)−G(1))/(T(2)−T(1)) where R is expected to fall in the range of pre-established threshold.

The present invention will determine the rate of the touches in relation to the GPS or radio frequency or cellular communication tracking method distance travelled by the vehicle.

If the present invention calculates results of the touches to indicate that the GPS or radio frequency or cellular communication tracking method position interval points to movement of the vehicle, the present invention will take action to disable the mobile cellular device text messaging operation.

The present invention uses a method that is not limited to looping through subsequent key presses process a new result set in pairs.

The present invention will clear result set after each pair entry which defined as first key after result set and second key after first key.

What is claimed is:

1. A method of detecting and disabling text messaging function on handheld communication device while the user of such device is operating a moving vehicle.

2. The method of detecting and disabling a text messaging function recited in claim 1; wherein the capture of input of first entry is stored in input register of the handheld communication device.

3. The method of detecting and disabling a text messaging function recited in claim 1; wherein the input of second entry is stored in input register of the handheld communication device.

4. A method of detecting and disabling text messaging function of handheld communication device. The method comprising: capturing the first input wherein the first input indicates the pending use of the text messaging function wherein the second input which consists of pressing another key is a confirmation and indicative of pending text messaging action. If the present invention logic calculates the captured time of input and GPS or Radio wave location of the first and second input produces a result that indicates a violation, the text messaging function will then be disabled.
